(19) United States
(12) Patent Application Publication
(10) Pub. No.: US 2014/0208347 A1
(43) Pub. Date: Jul. 24, 2014

(54) SYSTEM AND METHOD OF INVOLVING BROADCAST VIEWERS AND FUNDING PARTICIPANTS

(71) Applicant: Scott Brownsberger, El Segundo, CA (US)

(72) Inventor: Scott Brownsberger, El Segundo, CA (US)

(21) Appl. No.: 14/162,640

(22) Filed: Jan. 23, 2014

Related U.S. Application Data
(60) Provisional application No. 61/756,432, filed on Jan. 24, 2013.

(51) Int. Cl. H04N 21/81; B65D 85/00; H04N 21/435

(52) U.S. Cl. CPC H04N 21/812; H04N 21/435; B65D 85/70
USPC 725/32; 206/223

(57) ABSTRACT

A system and method for connecting a reality show or its participants to viewers on an individual level through an auxiliary system in which the viewer may purchase products associated with one or more of the participants of the game show, such as pay dirt containers associated with participants of a gold mining reality show.

### CROSS-REFERENCES TO RELATED APPLICATIONS

This application claims the benefit of U.S. Provisional Patent Application No. 61/756,432 filed Jan. 24, 2013, which is incorporated here in its entirety by this reference.

### BACKGROUND OF THE INVENTION

### Field of the Invention

The present invention pertains to broadcasts, such as reality shows, and more particularly to avenues for viewer involvement and interaction with the reality show or reality show participants and/or raising revenue for the reality show or its participants.

Reality shows have significantly increased in popularity. Viewers relate to participants as the participants tend to be regular people just like the viewers. Producers benefit from significant cost savings as they do not have to pay with high salaries demanded by professional actors and actresses. Numerous reality shows are competing with each other to win a loyal fan base. Therefore, there is a need to develop a method to draw in and maintain a loyal fan base for reality shows.

Viewership loyalty also increases as viewers' interaction with the show increases. Viewers who feel like they can contribute to the outcome or some other aspect of the show increases the connection the viewer has with the show. In reality shows in which viewers are able to participate, the viewers' participation is limited to deciding who stays on the show, who will be eliminated, or who will win the grand prize. Up to this point, it is not believed that any reality shows provide a method in which the viewers contribute directly to the revenue of the show or any participant on the show.

In addition, it is not believed that any reality show provides an opportunity for the viewers to make money from the show without the money coming from revenues for the show. Money tends to increase a person's interest in any activity. For example, a casual fan may enjoy a sporting event. But, if the casual fan has wagered on the sporting event, his interest is heightened tremendously by the potential of a financial windfall. Similarly, the average person may have absolutely no interest in the stock market. If he has invested in one or more stocks, however, his interest in that stock or the stock market general increases tremendously.

### BRIEF SUMMARY OF THE INVENTION

One embodiment of the present invention involves offering to viewers and audience members of a reality show the opportunity to purchase items that participants of the reality show create, produce, use, or otherwise interact with, thereby creating an additional degree of engagement between the viewer or audience member and the reality show or individual participants of the reality show.

Another embodiment of the present invention may involve offering to viewers and audience members of a reality show the opportunity to purchase items that participants of the reality show create, produce, use, or otherwise interact with, thereby creating an avenue for crowd funding of, or other revenue stream for, the reality show or individual participants of the reality show.

Another embodiment of the present invention may involve offering to viewers and audience members of a reality show the opportunity to purchase items that participants of the reality show create, produce, use, or otherwise, interact with, thereby creating an additional avenue for advertisements for the reality show, individual participants of the reality show, or the producer of the additional avenue.

Another embodiment of the present invention involves, effectively or actually, crowd funding the prospector teams, or otherwise providing an additional revenue stream for individual teams, especially where prospecting itself tends to offer only sporadic funding.

### BRIEF DESCRIPTION OF THE DRAWINGS

FIG. 1 is a diagram of individual components in one embodiment of the present invention showing potential interactions between them.

FIG. 2 is a diagram of a variation of the embodiment shown in FIG. 1.

FIG. 3 is a diagram showing the several elements of one embodiment of the present invention.

### DETAILED DESCRIPTION OF SOME EMBODIMENTS OF THE INVENTION

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

One embodiment of the present invention involves taking orders for a product associated with a reality show, completing the transaction, and delivering the ordered product to the buyer. One example of an embodiment the present invention would involve is a reality show like the existing show, Gold Rush. In Gold Rush, the experiences of real live gold prospectors are aired weekly, and a number of teams of prospectors compete, nominally, with one another to see which team finds the most gold in a given week or during some other time period. Viewers get to watch the several prospector teams, root for their favorites, and share (albeit, at a distance) in the fun, excitement, and anticipation of occasional large finds, etc.

One embodiment of the present invention is that the buyer or viewer may purchase a product associated with one or more particular participants of the reality show. In this way, the viewer can effectively root for his or her favorite participant(s) on the show and can feel an attachment to one of the participants, thereby increasing the viewer's loyalty to the show, loyalty to watching the show, and even get caught up emotionally with the successes and/or failures of the particular participant(s). In some embodiments, remuneration from the purchase can filter back to the associated reality show participant(s) in some way. The remuneration could result in a financial benefit or it could create other perks or privileges that can play out in the reality show itself.

For example, a viewer of Gold Rush may purchase a quantity of dirt from a given prospector team or location. The purchased dirt may be guaranteed to contain at least some gold and/or may be guaranteed and certified not to have been stripped of any naturally occurring gold. In some embodiments, some amount of gold may be added to the dirt so that the certification could guarantee at least some gold in every container so that the show can be assured that the purchasing viewer will always enjoy at least some amount of gold in his or her purchase.

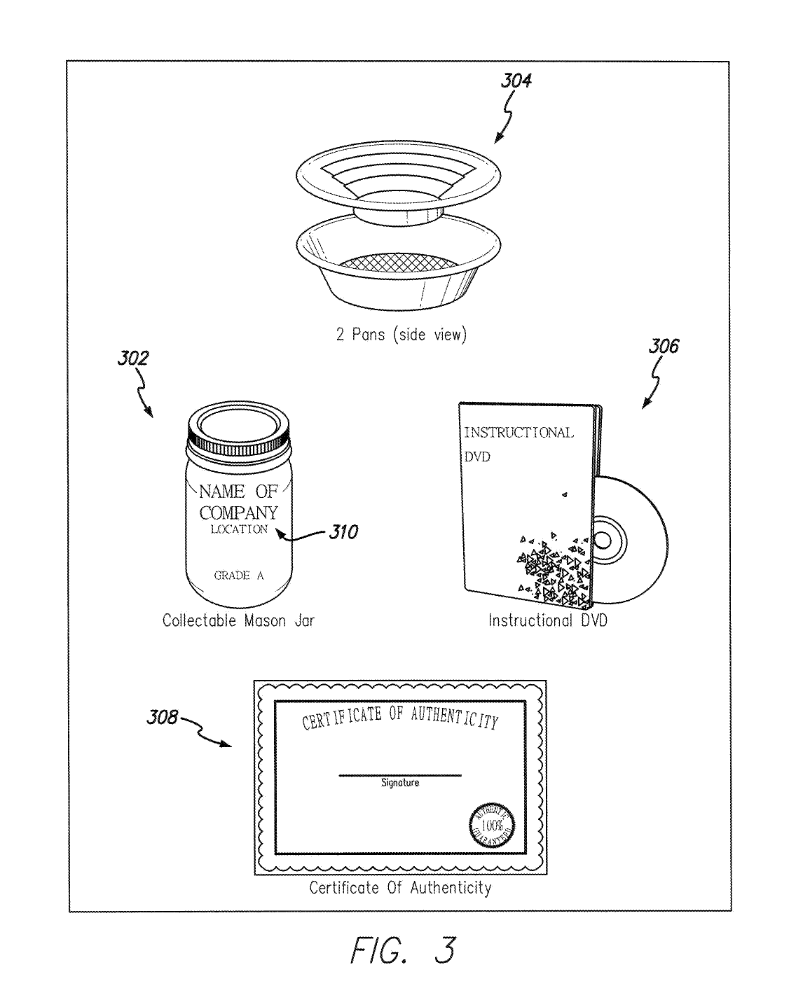

In some embodiments, the dirt could be accompanied by a gold mining kit. For example, if a viewer is purchasing dirt for the first time, the viewer may also wish to purchase a gold mining kit as shown in FIG. 3. The gold mining kit may comprise a container 302 containing the dirt, a pan 304 for panning for gold in the dirt, and an instructional video 306 on how to pan for gold. Additional items in the kit can include any other gold panning equipment, a certificate of authenticity 308, and/or a log for recording the amount of gold discovered inside. Alternatively, or subsequently, the viewers may simply purchase containers 302 with dirt having some quantity of gold.

In some embodiments, there may be different types, quality, or grade of dirt from which the viewers can choose. In addition, one container 302 may contain a variety of different types, qualities, or grades of dirt. Thus, the container 302 may contain primary dirt of one quality and secondary dirt or another quality. The type, quality or grade of dirt, referred to as the category of dirt or dirt category, is determined by the anticipated amount of gold a particular quantity of dirt is thought to contain. For example, the dirt may comprise top grade dirt, “pay dirt,” or dirt of potentially lesser value (meaning that it has a lower potential for high gold content). These levels may be verified by a professional gold miner who could then create the certificate of authenticity 308.

The viewer could also enroll in a periodic auto-ship program for purchasing the dirt on a weekly, monthly, annually, or other periodic basis. This gives the viewers the opportunity in reality to mine gold in their own homes and creates a method of increasing viewer interaction and raising revenue for the reality show and/or the particular participant that is associated with the purchase.

In some embodiments, the container 302 may have advertisements 310. For example, the container 302 may have labels, or may be engraved or embossed with advertisements. In some embodiments, the container 302 could contain a label prominently displayed thereon, thereby providing marketing for the upsale provider, product placement, charity promotions, such as when individual reality show participants promote their particular charities on the show, and/or reality show promotions.

In the preferred embodiment, the container 302 may be a standard masonry jar. The masonry jar may be embossed with the name of the mine from where the dirt was collected. The viewer also has the opportunity to purchase much larger quantities of dirt, such as in one-gallon, three-gallon, and five-gallon containers, or more.

The dirt may be sold on the reality show, on a website affiliated with the reality show, or in a separate infomercial or other direct-to-consumer program in which a promotion control controls aspects of the dirt sales.

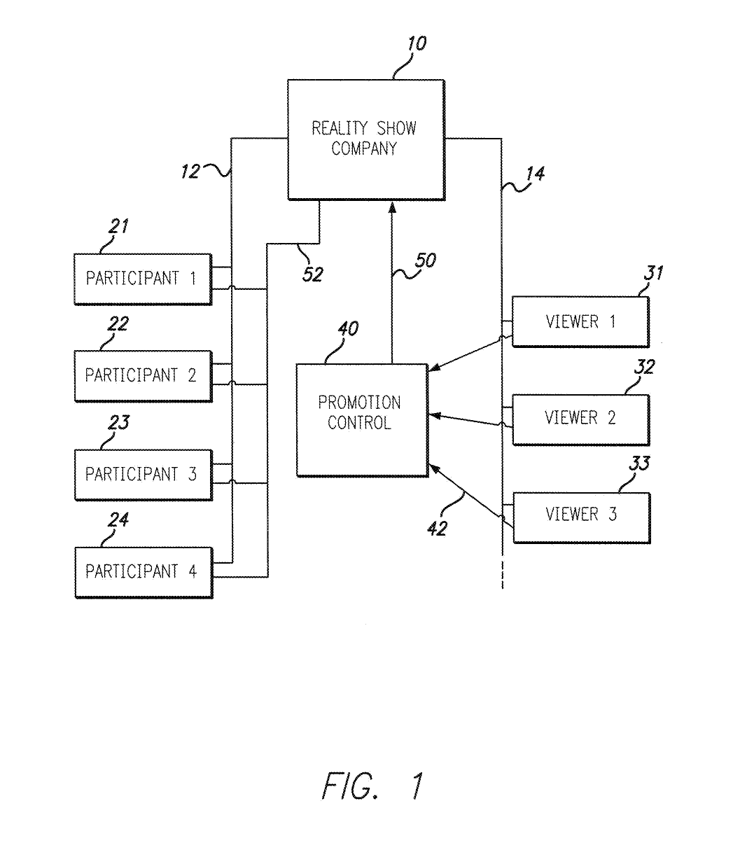

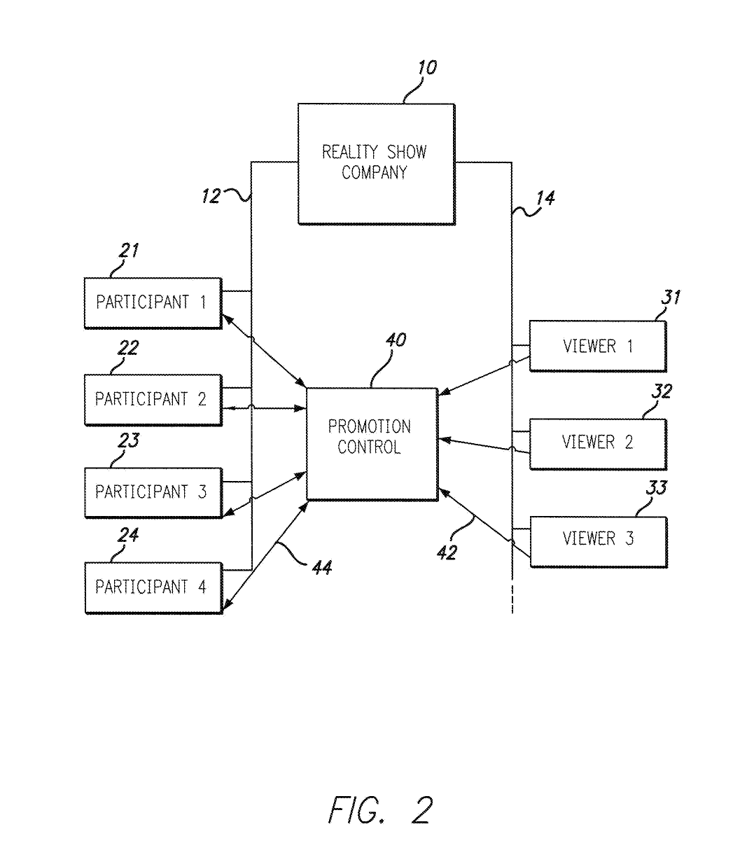

In some embodiments, as shown in FIGS. 1 and 2, to improve the viewership and interactivity of a reality show, the dirt can be sold directly on the reality show or through a promotional control. As the viewers 31-33 watch 14 the show 10, the viewers 31-33 will have an opportunity to request purchase of some dirt. This may occur by communicating through the show 10 or through a promotion control 40. If the viewer communicates 42 with the promotion control 40, the promotion control 40 in turn may communicate 50 with the reality show 10. The reality show 10 then communicates 12 with the participants 21-24 on the show accordingly so that the viewer's purchased dirt is properly collected.

As shown in FIG. 2, in some embodiments, the viewers 31-33 may communicate 42 directly with the promotion control 40 for the purchase of some dirt. The promotion control 40, then may communicate 44 directly with the participants 21-24 to collect the proper dirt.

In a subsequent show, the reality show 10 may televise the collection of the dirt requested by the viewers 31-33. This will heighten the viewers' 31-33 interests in watching the show as they anticipate, and possibly see, the dirt they purchased actually being collected on the reality show 10 by at least one of the participants 21-24.

By way of example only, on the reality show Gold Rush, there are already four different mining sites used on the show. The viewer may be offered the choice of which of the four locations the viewer would like his dirt to come from. In some embodiments, at each location, there may be at last two or more grades of dirt to buy, such as Pay Dirt Grade A, Pay Dirt Grade B, etc., each of which may have strict guidelines as to what makes up that category of dirt. These categories may be verified by a professional gold miner, and a certificate of authenticity 308 may be generated and sent with each purchase. In some embodiments, each pay dirt grade could likewise comprise two or more sub-grades of dirt, each coming with its own certification. The container used to transport the dirt may be embossed with the name of the mine the dirt is from.

It is anticipated that some collectors may not open the containers 302 at all, but instead purchase dirt from one or all mining sites as a complete collection. Promotionals or advertising for the kit or containers would be presented on the show, Gold Rush, and/or other gold mining shows.

In some embodiments, rather than selecting the site from which the viewers 31-33 can get their dirt, the viewers may select an individual player or a team (eg. Participants 21-24) on the show to follow and purchase portions of the dirt collected by those participants 21-44. This increases a viewer's loyalty to a particular participant 21-44.

Another means for increasing a viewer's 31-33 loyalty to the show, team, or player (i.e., Participants 21-44) is to have all or a portion of the proceeds from the sale of the dirt go to the show, or the participant 21-24 selected by the viewers 31-33. Thus, if viewers 31-33 select participants 21-24 with which the viewers 31-33 would like to be affiliated with, the proceeds of any sales of dirt to these viewers 31-33 would go to their respective selected participants 21-24.

By having the viewers 31-33 supply funds to the participants 21-44, the participants 21-24 will tend to entertain and cater to their viewers 31-33 making the show more entertaining This will also save money for the reality show since it could reduce the amount of pay the show gives to the participants 21-24.

In another embodiment, direct marketing television can be used to sell the dirt and/or kit. Thus, the direct marketing television functions as a promotion control 40 for the reality show 10. Alternatively, the promotion control 40 can be affiliated with mining sites across the country or the world and use direct marketing television, such as infomercials, to market the kit or dirt to viewers irrespective of any reality show.

Therefore, viewers 31-33 can watch or interact with a reality show 10 and purchase dirt containing gold, and the reality show 10 can inform the participants 21-24 on the show regarding the purchases made by the viewers' 31-33 so that the participants 21-24 can act accordingly. In some embodiments, viewers 31-33 may watch or interact with the promotion control 40, the promotion control 40 can interact with the reality show company 10, which can then instruct the participants 21-24 regarding the viewers' 31-33 purchases to allow the participants 21-24 to act accordingly. Alternatively, the viewers 31-33 may watch or interact with the promotional control 40, and the promotional control 40 can instruct the participants 21-24 regarding the viewers' 31-33 purchases to allow the participants 21-24 to act accordingly. The viewers 31-33 can then watch the reality show 10 and see how their purchases affect the show.

While the present invention has been described with regards to particular embodiments, it is recognized that additional variations of the present invention may be devised without departing from the inventive concept.

What is claimed is:

1. A kit for sale on a reality show, the kit comprising:
a. a container filled with primary dirt containing gold, wherein a quality of the primary dirt is selected from the group consisting of pay dirt grade and top soil grade;
b. a pan for panning the dirt for the gold;
c. an instructional video recorded on a machine readable media to instruct on how to use the kit; and
d. a certificate of authenticity to warrant the quality of the dirt.

2. The kit of claim 1, wherein the container comprises an advertisement.

3. The kit of claim 1, wherein the container is a masonry jar.

4. The kit of claim 3, wherein the masonry jar is embossed with a name of a mine from where the primary dirt was collected.

5. The kit of claim 1, wherein the container comprises secondary dirt of lesser quality than the primary dirt.

6. The kit of claim 1, wherein the quality of the primary dirt determines the amount of gold in the primary dirt.

7. A method of advertising, comprising offering a gold mining kit,
a. the gold mining kit comprising:
i. a container having dirt containing gold, wherein a quality of the dirt is selected from the group consisting of pay dirt grade and top soil grade;
ii. a gold panning equipment to pan the dirt for the gold;
iii. an instructional video recorded on a machine readable media to instruct on how to use the kit; and
iv. a certificate of authenticity to warrant the quality of the dirt,
b. wherein the gold mining kit is offered on a gold mining reality show.

8. The method of claim 7, further comprising offering a renewal service to ship additional dirt samples on a periodic schedule.

9. The method of claim 7, further comprising offering a selection of mining sites from where the dirt can be obtained, wherein a mining site available for selection is one of the mining sites on the gold mining reality show.

10. The method of claim 9, wherein the step of obtaining the dirt is televised on the gold mining reality show.

11. The method of claim 9, wherein the dirt is from a participant on the gold mining reality show.

12. The method of claim 11, further comprising allocating a portion of a sale from the dirt obtained from the participant for the participant.

13. A method of advertising, comprising offering a container filled with primary dirt containing gold, wherein a quality of the primary dirt is selected from the group consisting of pay dirt grade and top soil grade.

14. The method of claim 13, further comprising offering a gold mining kit, the gold mining kit comprising:
a. the container filled with the dirt containing gold;
b. a gold panning equipment to pan the dirt for the gold;
c. an instructional video recorded on a machine readable media to instruct on how to use the kit; and
d. a certificate of authenticity to warrant the quality of the dirt.

15. The method of claim 13, further comprising offering a renewal service to ship additional dirt samples on a periodic schedule.

16. The method of claim 13, further comprising offering a selection of mining sites from where the dirt can be obtained.

17. The method of claim 16, wherein a mining site available for selection is one of the mining sites on a gold mining reality show.

18. The method of claim 17, wherein the step of obtaining the dirt is televised on the gold mining reality show.

19. The method of claim 17, wherein the dirt is from a team on the gold mining reality show.

20. The method of claim 17, further comprising allocating a portion of a sale from the dirt to at least one participant on the gold mining reality show.
